(19) United States
(12) Patent Application Publication
(10) Pub. No.: US 2023/0396088 A1
(43) Pub. Date: Dec. 7, 2023

(54) ELECTRONIC APPARATUS AND CONTROLLING METHOD THEREOF

(71) Applicant: Samsung Electronics Co., Ltd., Suwon-si (KR)

(72) Inventors: Ankit YADU, Bengaluru (IN); Subramanian Swernath BRAHMADATHAN, Bengaluru (IN); Samarth AGARWAL, Bengaluru (IN); Krishnan S. HARIHARAN, Bengaluru (IN); Seongho HAN, Bengaluru (IN); Sangheon LEE, Suwon-si (KR)

(21) Appl. No.: 18/347,880

(22) Filed: Jul. 6, 2023

Related U.S. Application Data
(63) Continuation of application No. PCT/KR2023/007044, filed on May 24, 2023.

(30) Foreign Application Priority Data
Jun. 7, 2022 (KR) 202241032429

(51) Int. Cl. H02J 7/00

(52) U.S. Cl. CPC H02J 7/0071; H02J 7/0047; H02J 7/00714; H02J 7/007192

(57) ABSTRACT

A method for on-device real-time customization of charge profiles for a battery in an electronic device, and/or a corresponding device. The method may include determining at least one charging behavior parameter of the battery during every charging cycle. Further, the method may include determining at least one discharging behavior parameter of the battery subsequent to every charging cycle. Further, the method may include generating a charging profile for charging the battery based on the at least one charging behavior parameter and the at least one discharging behavior parameter. Further, the method may include charging the battery using the generated charging profile for the subsequent charging-discharging cycles.

### CROSS REFERENCE TO RELATED APPLICATION

This application is a continuation of International Application PCT/KR2023/007044, filed on May 24, 2023, which is based on and claims priority on IN Patent Application No. 202241032429 filed on Jun. 7, 2022, the disclosures of which are all hereby incorporated herein by reference in their entireties.

### BACKGROUND

### Field

Certain example embodiments relate to battery management systems and/or methods, and for example to a method and/or an electronic device for an on-device real-time customization of charge profiles for a battery in the electronic device.

### Description of Related Art

The existing methods and systems provide a static implementation of charge profiles of a battery. The charge profiles do neither take into account user's need nor battery health status so as to results in reducing a user experience and degrading the battery performance. Further, battery temperature and usage behaviour (behavior) have a huge impact on battery charging and still they are not taken into account. In different operating conditions, fixed charge profiles must not be presumed to meet the controlled environment results. Also, the existing methods and systems do not cater well in different operating/usage conditions (e.g., temperature throttling of the battery, user involvement of the battery, or the like) so as to results in reducing the user experience.

Further, the existing methods and systems attempt to generate an adaptive charge profile for the battery, but the existing methods and systems requires extra circuitry/hardware elements and look-up data information. The existing methodology is incapable of generating custom real-time charge profiles as per user's requirement.

Thus, it is desired to address the above mentioned disadvantages or other shortcomings or at least provide a useful alternative.

### SUMMARY

Certain example embodiments provide a method and/or an electronic device for an on-device real-time customization of charge profiles for a battery in the electronic device, so as to provide a personalized experience with enhanced battery performance. The charging profile can be modified at run-time to cater user need with enhanced battery performance. The modifications may require minimal or a reduced amount of changes. The safety constraints can be imposed via the proposed method easily. The charge profiles are safe against the effect of temperature throttle of the battery. The proposed method may be capable of generating custom real-time charge profiles as per user's requirement.

An example embodiment is to provide a method for on-device real-time customization of charge profiles for a battery in an electronic device. The method may include determining, by the electronic device, at least one charging behavior parameter of the battery during every charging cycle. Further, the method may include determining, by the electronic device, at least one discharging behavior parameter of the battery subsequent to every charging cycle. Further, the method may include generating, by the electronic device, a charging profile for charging the battery based on the at least one charging behavior parameter and the at least one discharging behavior parameter. Further, the method may include charging, by the electronic device, the battery using the generated charging profile for the subsequent charging-discharging cycles.

In an example embodiment, the plurality of charging profiles may be generated by applying at least one machine learning model on the at least one charging behavior parameter, and the at least one discharging behavior parameter of the battery.

In an example embodiment, the method may include determining, by the electronic device, usage characteristics of the electronic device. Further, the method includes modifying, by the electronic device, the generated charging profile based on the usage characteristics of the electronic device. Further, the method may include charging, by the electronic device, the battery using the modified charging profile.

In an example embodiment, the usage characteristics may comprise at least one of: a user type, a current location of the electronic device, calendar events, current health characteristics of the battery, and current context of the user.

In an example embodiment, the user type may comprise at least one of an aggressive user having full fast charging requirement, an aggressive user having partial fast charging requirement, a passive user having fast charging with better life requirement, a passive user having balanced charging requirement, and a passive user having life squeezer charging requirement.

In an example embodiment, the at least one charging behavior parameter may comprise a charging duration for which the battery is charged, a cable plugin time, a number of times, the cable is plugged in, a charging rate, a charging instance of day, and a cable plug out time.

In an example embodiment, the at least one discharging behavior parameter may comprise an amount of battery consumed by each application of the electronic device, a duration of battery consumption of each application of the electronic device, a calendar input, a discharge rate of the battery, and a discharging instance of day for significantly different discharge rate.

In an example embodiment, the current health characteristics of the battery may comprise a state of charge of the battery, a state of health of battery, a temperature of the device and surrounding, a resistance or equivalent of the battery, a fault/abuse of the battery, and a remaining usage life of the battery.

Accordingly, an example embodiment may provide an electronic device for on-device real-time customization of charge profiles for a battery in an electronic device. The electronic device may include a charge profile customization controller coupled to, directly or indirectly, a memory and a processor comprising processing circuitry. The charge profile customization controller, comprising processing circuitry, may be configured to determine at least one charging behavior parameter of the battery during every charging cycle. Further, the charge profile customization controller may be configured to determine at least one discharging behavior parameter of the battery subsequent to every charging cycle. Further, the charge profile customization controller may be configured to generate a charging profile for charging the battery based on the at least one charging behavior parameter and the at least one discharging behavior parameter. Further, the charge profile customization controller may be configured to charge the battery using the generated charging profile for the subsequent charging-discharging cycles.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF DRAWINGS

The example embodiments are illustrated in the accompanying drawings, throughout which like reference letters indicate corresponding parts in the various figures. The example embodiments herein will be better understood from the following description with reference to the drawings, in which:

FIG. 1 shows various hardware components of an electronic device for on-device real-time customization of charge profiles for a battery in the electronic device, according to certain example embodiments;

FIG. 2 is a flow chart illustrating a method for the on-device real-time customization of charge profiles for the battery in the electronic device, according to certain example embodiments; and

FIG. 3 is an example flow chart illustrating a method for adjusting a user profile for charging the battery in the electronic device, according to certain example embodiments.

FIG. 4 illustrates an operation for managing the battery of an example electronic device.

FIG. 5 is a view provided to explain example User Factors (or User Type).

FIG. 6 is a graph provided to explain charging time and current according to one or more example embodiments.

FIG. 7 is a graph provided to explain charging time and current according to one or more example embodiments.

FIG. 8 is a view provided to explain an example operation of determining a battery profile according to a user behavior.

FIG. 9 is a view provided to explain an example battery-related operation of the electronic device.

FIG. 10 is a view provided to explain a relationship between a charging time and a battery state according to various example user factors.

FIG. 11 is a view provided to explain a controlling method of the electronic device according to one or more example embodiments.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure. Thus, for example, each module and unit herein may comprise circuitry.

Accordingly, the embodiment herein is to disclose a method for on-device real-time customization of charge profiles for a battery in an electronic device. The method includes determining, by the electronic device, at least one charging behavior parameter of the battery during every charging cycle. Further, the method includes determining, by the electronic device, at least one discharging behavior parameter of the battery subsequent to every charging cycle. Further, the method includes generating, by the electronic device, a charging profile for charging the battery based on the at least one charging behavior parameter and the at least one discharging behavior parameter. Further, the method includes charging, by the electronic device, the battery using the generated charging profile for the subsequent charging-discharging cycles.

The proposed method can be used to provide a personalized charging profile which keeps each user happier with the electronic device/battery performance and provide a battery brand value enhancement. The charging profile can be modified at run-time to cater user need with enhanced battery performance. The modifications require no, minimal, or small changes and less time. The safety constraints can be imposed via the proposed method easily. The charge profiles are safe against the effect of temperature throttle of the battery. The proposed method provides more insights about the user, so as to enhance the user experience at run time. The proposed method can be used to control the personalized charging profile in the electronic device with less time and low cost.

The proposed method can be used to support different charge profiles with a same adapter, so as to provide a personalized battery performance. The proposed method can be used to handle a pre-empts temperature throttling, so as to avoid a battery heating and fill a full capacity in the battery.

The proposed method can be used to support multiple fast charging profiles with same adapter, so as to avoid battery heating with minimal or reduced battery degradation. The proposed method can be used to support multiple life saver profiles, such that a battery life can be extended and positive impact on battery brand value. The life saver is a type of charge profile which charges the battery in a manner to minimize or reduce the degradation with slight increase in charge time.

The proposed method can take users input to suggest relevant charge profiles as per user need so as to provide the personalized battery performance. The proposed method can be used to provide the charge profile with a mix of time and life-saving criteria, so as to save time with initial quick burst, control battery life and provide the personalized battery performance. The proposed method is capable of generating custom real-time charge profiles as per user's requirement.

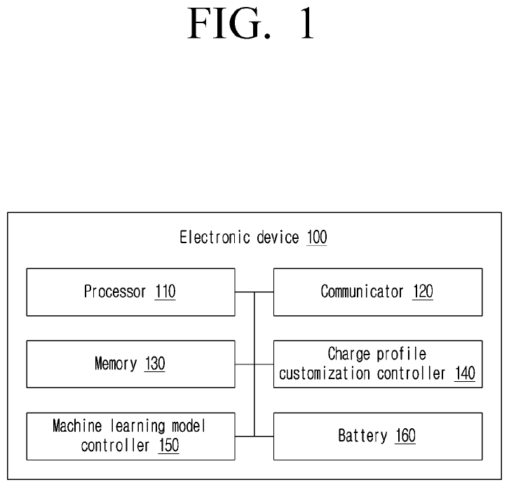

Referring now to the drawings and more particularly to FIGS. 1 through 3, where similar reference characters denote corresponding features consistently throughout the figures, there are shown preferred embodiments.

FIG. 1 shows various hardware components of an electronic device (100) for on-device real-time customization of charge profiles for a battery (160) in the electronic device (100), according to certain example embodiments. The electronic device (100) can be, for example, but not limited to a laptop, a desktop computer, a notebook, a relay device, a Device-to-Device (D2D) device, a vehicle to everything (V2X) device, a smartphone, a tablet, an immersive device, and an internet of things (IoT) device. The battery (160) can be, for example, but not limited to a Lithium (Li)-ion battery, a Li-polymer battery, a Nickel-Cadmium battery, a Lead-Acid battery or the like.

In an embodiment, the electronic device (100) includes a processor (110), a communicator (120), a memory (130), a charge profile customization controller (140), a machine learning model controller (150) and the battery (160). The processor (110) is coupled with the communicator (120), the memory (130), the charge profile customization controller (140), the machine learning model controller (150) and the battery (160).

The charge profile customization controller (140) determines one or more charging behavior parameter(s) of the battery (160) during every charging cycle. The one or more charging behavior parameter(s) can be, for example, but not limited to a charging duration for which the battery (160) is charged, a cable plugin time, a number of times the cable is plugged in, a charging rate, a charging instance of day, and a cable plug out time.

Further, the charge profile customization controller (140) determines one or more discharging behavior parameter(s) of the battery (160) subsequent to every charging cycle. The one or more discharging behavior parameter(s) can be, for example, but not limited to an amount of the battery (160) consumed by each application of the electronic device (100), a duration of battery consumption of each application of the electronic device (100), a calendar input, a discharge rate of the battery (160), and a discharging instance of day for significantly different discharge rate. The application can be, for example, but not limited to a game application, a chat application, a social media application, a map application or the like.

Based on the one or more charging behavior parameter(s) and the one or more discharging behavior parameter(s), the charge profile customization controller (140) generates a charging profile for charging the battery (160). The charging profile is generated by applying one or more machine learning (ML) model(s) on the one or more charging behavior parameter(s), and the one or discharging behavior parameter(s) of the battery (160) using the machine learning model controller (150). Further, the charge profile customization controller (140) charges the battery (160) using the generated charging profile for subsequent charging-discharging cycles.

The charge profile is customized for a particular user after analysing user's charge and discharge behavior. The charge profile is customized in terms of charge time, charge trajectory and degradation. The charge profile can be, for example, but not limited to a retro charging profile, an optimistic charging profile, an aggressive charging profile, and a balanced charging profile.

The retro charging profile is used by a user who plug in the charger cable all the time. The retro charging profile may be used in overnight charging, during long work hours, while travelling in cars etc. The optimistic charging profile is used by the user who want more life from the battery (160) with minimal or small increase in charge time. The aggressive charging profile provides a quick charging before meeting or quick boost when the battery (160) is fully drained or sudden travel plan without charge connection availability etc. The aggressive charging profile provides the quick charging at electrical vehicle (EV) station for an EV. The balanced charging profile is used by a user who need initial quick burst and still want to maintain decent battery life.

In another embodiment, the charge profile customization controller (140) measures an amount of time for which the battery (160) is charged, during every charging cycle and monitors a discharge pattern due to usage of the electronic device (100), subsequent to every charging cycle. The charge profile customization controller (140) applies the charging profile in response to the measured time and discharge pattern such that battery operation is optimized (e.g. minimum degradation, temperature control, charging time etc.).

Further, the charge profile customization controller (140) generates the AI model including a correlation of the time, discharge pattern and the charging profile that minimizes or reduces the rate of discharge of the battery (160). The AI model selects the charging profile in response to time and discharge pattern of the battery (160). The current battery characteristics (e.g. temperature of the battery) is also fed as an input to the AI model.

Further, the charge profile customization controller (140) determines usage characteristics of the electronic device (100) and modifies the generated charging profile based on the usage characteristics of the electronic device (100). The usage characteristics can be, for example, but not limited to a user type, a current location of the electronic device (100), calendar events, current health characteristics of the battery (160), and current context of the user. The user type can be, for example, but not limited to an aggressive user having full fast charging requirement, an aggressive user having partial fast charging requirement, a passive user having fast charging with better life requirement, a passive user having balanced charging requirement, and a passive user having life squeezer charging requirement. The current health characteristics of the battery (160) can be, for example, but not limited to a state of charge of the battery (160), a state of health of battery (160), a temperature of the electronic device (100), surrounding of the electronic device (100), a resistance or equivalent of the battery (160), a fault of the battery (160), and a remaining usage life of the battery (160). By using the modified charging profile, the charge profile customization controller (140) charges the battery (160).

The charge profile customization controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120), comprising communication circuitry, is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Further, at least one of the pluralities of modules/controller may be implemented through the AI model using the machine learning model controller (150). The data driven controller can be a ML model based controller and AI model based controller. A function associated with the AI model may be performed through the non-volatile memory, the volatile memory, and the processor (110). The processor (110) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning indicates that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the FIG. 1 shows various hardware components of the electronic device (100) but it is to be understood that other embodiments are not limited thereon. In other embodiments, the electronic device (100) may include less or more number of components. Further, the labels or names of the components are used only for illustrative purpose and does not limit the scope. One or more components can be combined together to perform same or substantially similar function in the electronic device (100).

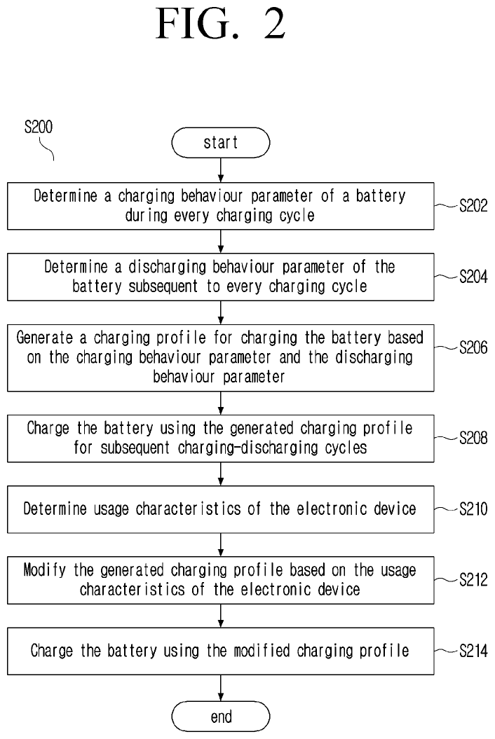

FIG. 2 is a flow chart (S200) illustrating a method for the on-device real-time customization of charge profiles for the battery (160) in the electronic device (100), according to certain example embodiments. The operations (S202-S214) are handled by the charge profile customization controller (140).

At S202, the method includes determining the charging behavior parameter of the battery (160) during every charging cycle. At S204, the method includes determining the discharging behavior parameter of the battery (160) subsequent to every charging cycle. At S206, the method includes generating the charging profile for charging the battery (160) based on the charging behavior parameter and the discharging behavior parameter. At S208, the method includes charging the battery (160) using the generated charging profile for the subsequent charging-discharging cycles.

At S210, the method includes determining the usage characteristics of the electronic device (100). At S212, the method includes modifying the generated charging profile based on the usage characteristics of the electronic device (100). At S214, the method includes charging the battery (160) using the modified charging profile.

The proposed method can be used to support different charge profiles with the same adapter, so as to provide the personalized battery performance. The proposed method can be used to handle the pre-empts temperature throttling, so as to avoid the battery heating and fill the full capacity in the battery (160). The proposed method can also be used to support multiple fast charging profiles with same adapter, so as to avoid battery heating with no, minimal, or reduced battery degradation. The proposed method can be used to support multiple life saver profiles, such that a battery life can be extended and positive impact on battery brand value.

The proposed method can take users input to suggest relevant charge profiles as per user need so as to provide a personalized battery performance. The proposed method provides the charge profile with a mix of time and life-saving criteria, so as to save time with initial quick burst, controls battery life and provide a personalized battery performance.

The charging profile results in longer life of battery (160) when the battery charging behavior is found to be of slow nature.

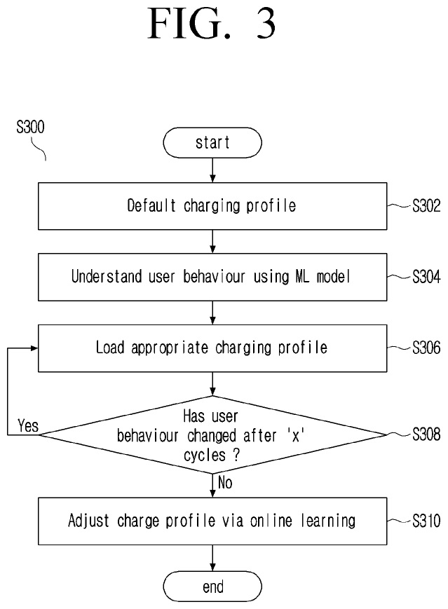

FIG. 3 is an example flow chart (S300) illustrating a method for adjusting the user profile for charging the battery (160) in the electronic device (100), according to certain example embodiments. The operations (S302-S310) are handled by the charge profile customization controller (140).

At S302, the electronic device (100) uses the default charging profile. At S304, the electronic device (100) understands the user behavior over the period of time using the ML model. At S306, the electronic device (100) loads the appropriate charging profile based on the user behavior. At S308, the electronic device (100) determines whether the user behavior has changed after ‘x’ cycles? In response to determining that the user behavior has changed after ‘x’ cycles then, at S306, the electronic device (100) loads the appropriate charging profile based on the user behavior after ‘x’ cycles. In response to determining that the user behavior is not changed after ‘x’ cycles then, at S310, the electronic device (100) adjusts the user profile via online learning.

The proposed method can also be applicable to an electrical vehicle (EV), a hybrid vehicle or the like.

The various actions, acts, blocks, steps, or the like in the flow charts (S200 and S300) may be performed in the order presented, in a different order or simultaneously. Further, in some embodiments, some of the actions, acts, blocks, steps, or the like may be omitted, added, modified, skipped, or the like without departing from the scope.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

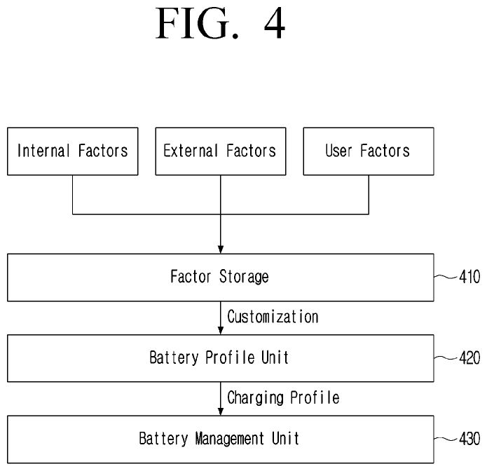

FIG. 4 illustrates an operation for managing the battery of the electronic device.

The electronic device (100) may include at least one of Factor Storage (410), Battery Profile Unit (420) or Battery Management Unit (430).

Factor Storage (410) may obtain a plurality of factors for a Battery Profile. The battery profile may include at least one of a charging profile or a discharging profile.

The battery profile may indicate a detailed control method related to charging or discharging of a battery. For example, the battery profile may include a detailed parameter capable of controlling charging speed, discharging speed, charging time, discharging time, etc.

The battery profile may described as a battery usage profile.

The battery profile may described as a charging/discharging profile.

The battery profile may described as a battery usage profile.

The battery profile may described as a battery usage pattern.

The charging profile may include at least one parameter for charging the battery of the electronic device (100).

The discharging profile include at least one parameter for discharging the battery of the electronic device (100).

Parameters included in the charging profile and parameters included in the discharging profile may partially overlap.

The plurality of factors may store as factor information including at least one of internal factors, external factors or user factors.

The internal factors may include information corresponding to hardware/software components of electronic device (100).

The hardware components of the internal factors may include information regarding at least one of memory usage, remaining battery power or whether a specific hardware configuration is operated.

For example, information regarding whether a specific hardware configuration is operated may include whether a communication interface is operated or whether an image of a display is output.

The software components of the internal factors may include information related to an application that is being executed. The information related to an application may include at least one of name, type, required memory, or execution time.

The external factors may include information related to the location of the external device (100). The information related to the location may be described as environment information.

The information related to the location may indicate information affecting charging speed or discharging speed of a battery. For example, the information related to the location may include at least one of temperature of humidity.

The electronic device (100) may obtain the external factors through at least one sensor of the electronic device (100). The electronic device (100) may obtain temperature information surrounding with the electronic device (100) through a temperature sensor. The electronic device (100) may obtain humidity information surrounding with the electronic device (100) through a humidity sensor.

The user factors may include information related with a user behavior. The user behavior may include at least one of charging behavior or discharging behavior. The user factors may described as a user type.

The charging behavior may include behavior for charging the battery of the electronic device (100). For example, a habit of fast charging once a day, etc. may correspond to a charging behavior.

The discharging behavior may include behavior for discharging the battery of the electronic device (100). For example, a habit of using an application that consumes a battery fast, etc. may be included in a discharging behavior.

The electronic device (100) may store at least one factor for the battery profile in the Factor Storage (410).

The Factor Storage (410) may transmit the stored at least one factor to the Battery Profile Unit (420).

The Battery profile Unit (420) may obtain the at least one factor from the Factor Storage (410). The Battery Profile Unit (420) may analysis the at least one factor. The Battery Profile Unit (420) may obtain a battery profile based on the at least one factor. The Battery Profile Unit (420) may transmit the battery profile to the Battery Management Unit (430). Each “unit” herein may comprise circuitry.

According to at least one of embodiments, the Battery Profile Unit (420) may generate a battery profile based on the at least one factor.

According to at least one of embodiments, the Battery Profile Unit (420) may update (or change) a battery profile based on the at least one factor. The updated battery profile may be a profile that was already generated in the Battery Profile Unit (420) at a time before the update operation is performed.

The Battery Profile Unit (420) may transmit the generated battery profile (or the updated battery profile) to the Battery Management Unit (430).

The Battery Management Unit (430) may receive the generated battery profile (or the updated battery profile). The Battery Management Unit (430) may perform a function corresponding to the battery based on the receive battery profile. The Battery Management Unit (430) may perform a charging function (or discharging function) related with the battery based on the received battery profile.

The Battery Management Unit (430) may control the electronic device (100) based on the received battery profile. The Battery Management Unit (430) may charge the battery based on the received battery profile.

For example, the Battery Management Unit (430) may control a processor included in the electronic device (100) based on the received battery profile so that the performance degradation of the electronic device 100 is minimized or reduced.

For example, the Battery Management Unit (430) may control a temperature of the electronic device (100) based on the received battery profile. The electronic device 100 may control the temperature of the electronic device (100) to be below a threshold value. The electronic device (100) may perform a predetermined operation so that the temperature of the electronic device (100) is maintained below a threshold value.

The predetermined operation may include at least one of operating a fan, changing the rotational strength of the fan to be fast, or performing a cooling function.

For example, the Battery Management Unit (430) may control a charging time (or a discharging time) of the battery based on the received battery profile.

The electronic device (100) may increase (or decrease) the charging time of the battery based on the received battery profile. The electronic device (100) may charge (or discharge) the battery based on the charging time corresponding to the battery profile.

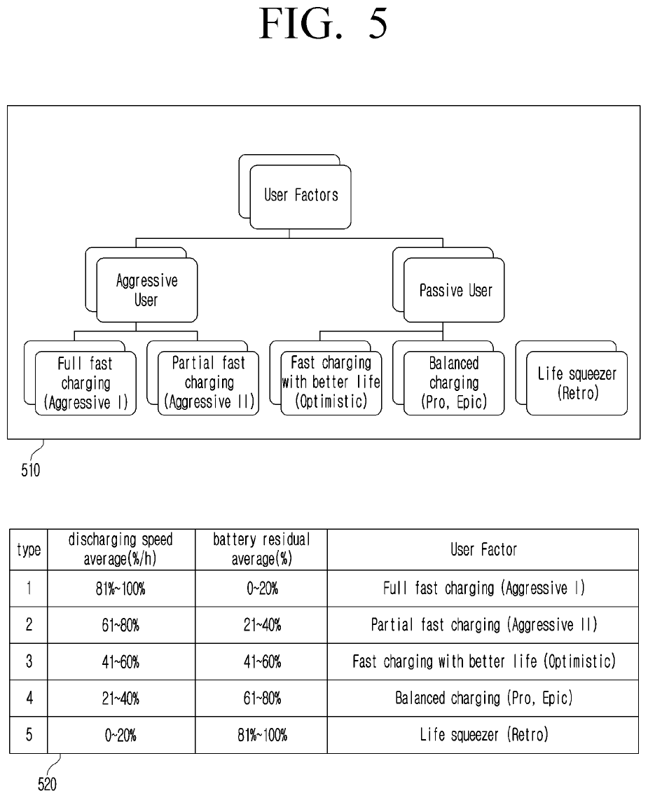

FIG. 5 is a view provided to explain User Factors (or User Type).

Referring to an embodiment (510), user factors may be divided into Aggressive User type and Passive User type.

The Aggressive User type may be divided into Full fast charging (Aggressive I) type and Partial fast charging (Aggressive II) type.

The Passive User type may be divided into Fast charging with better life (Optimistic) type, Balanced charging (Pro, Epic) type, and Life squeezer (Retro) type.

Full fast charging (Aggressive I) type, Partial fast charging type (Aggressive II), Fast charging with better life (Optimistic) type, Balanced charging (Pro, Epic) type, Life squeezer (Retro) type may described as a first user type, a second user type, a third user type, a fourth user type, a fifth user type, respectively.

Referring to the table (520), the electronic device (100) may identify the user factor (or user type) based on the at least one of the discharging speed average or the battery residual average.

The electronic device (100) may obtain at least one of the discharging speed or the battery residual during a pre-determined period. The electronic device (100) may obtain at least one of the discharging speed average or the battery residual average based on the at least one of the discharging speed or the battery residual during the pre-determined period.

The electronic device (100) may identify the Full fast charging (Aggressive I) type based on the at least one of the discharging speed average or the battery residual average.

Based on the discharging speed average being included in a threshold range (e.g. 81%˜100%), the electronic device (100) may identify the user factor as the Full fast charging (Aggressive I) type.

Based on the battery residual average being included in a threshold range (e.g. 0%˜20%), the electronic device (100) may identify the user factor as the Full fast charging (Aggressive I) type.

Based on the discharging speed average being included in a threshold range (e.g. 81%˜100%) and based on the battery residual average being included in a threshold range (e.g. 0%˜20%), the electronic device (100) may identify the user factor as the Full fast charging (Aggressive I) type.

The electronic device (100) may identify the Partial fast charging (Aggressive II) type based on the at least one of the discharging speed average or the battery residual average.

Based on the discharging speed average being included in a threshold range (e.g. 61%˜80%), the electronic device (100) may identify the user factor as the Partial fast charging (Aggressive II) type.

Based on the battery residual average being included in a threshold range (e.g. 21%˜40%), the electronic device (100) may identify the user factor as the Partial fast charging (Aggressive II) type.

Based on the discharging speed average being included in a threshold range (e.g. 61%˜80%) and based on the battery residual average being included in a threshold range (e.g. 21%˜40%), the electronic device (100) may identify the user factor as the Partial fast charging (Aggressive II) type.

The electronic device (100) may identify the Fast charging with better life (Optimistic) type based on the at least one of the discharging speed average or the battery residual average.

Based on the discharging speed average being included in a threshold range (e.g. 41%˜60%), the electronic device (100) may identify the user factor as the Fast charging with better life (Optimistic) type.

Based on the battery residual average being included in a threshold range (e.g. 41%˜60%), the electronic device (100) may identify the user factor as the Fast charging with better life (Optimistic) type.

Based on the discharging speed average being included in a threshold range (e.g. 41%˜60%) and based on the battery residual average being included in a threshold range (e.g. 41%˜60%), the electronic device (100) may identify the user factor as the Fast charging with better life (Optimistic) type.

The electronic device (100) may identify the Balanced charging (Pro, Epic) type based on the at least one of the discharging speed average or the battery residual average.

Based on the discharging speed average being included in a threshold range (e.g. 21%˜40%), the electronic device (100) may identify the user factor as the Balanced charging (Pro, Epic) type.

Based on the battery residual average being included in a threshold range (e.g. 61%˜80%), the electronic device (100) may identify the user factor as the Balanced charging (Pro, Epic) type.

Based on the discharging speed average being included in a threshold range (e.g. 21%˜40%) and based on the battery residual average being included in a threshold range (e.g. 61%˜80%), the electronic device (100) may identify the user factor as the Balanced charging (Pro, Epic) type.

The electronic device (100) may identify the Life squeezer (Retro) type based on the at least one of the discharging speed average or the battery residual average.

Based on the discharging speed average being included in a threshold range (e.g. 0%˜20%), the electronic device (100) may identify the user factor as the Life squeezer (Retro) type.

Based on the battery residual average being included in a threshold range (e.g. 81%˜100%), the electronic device (100) may identify the user factor as the Life squeezer (Retro) type.

Based on the discharging speed average being included in a threshold range (e.g. 0%˜20%) and based on the battery residual average being included in a threshold range (e.g. 81%˜100%), the electronic device (100) may identify the user factor as the Life squeezer (Retro) type.

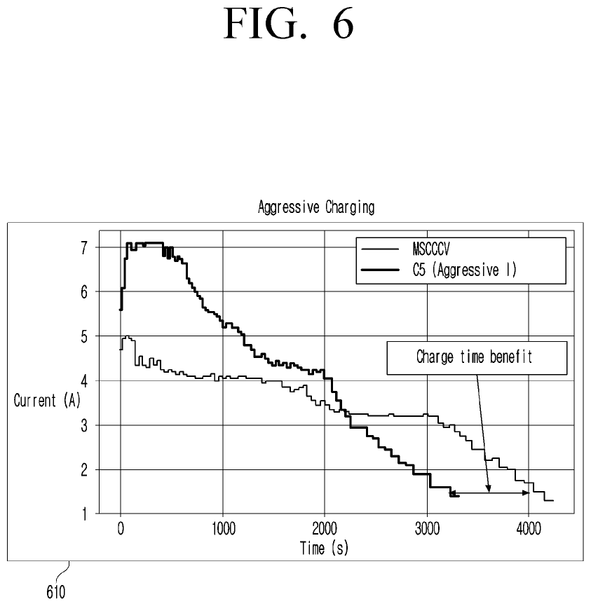

FIG. 6 is a graph provided to explain charging time and current according to one or more embodiments.

In the graph (610) of FIG. 6, an embodiment of charging a battery using MSCCCV (Multi-Step Constant Current Constant Voltage) type and an embodiment of charging a battery using a battery profile corresponding to Aggressive I type may be compared.

In the embodiment of charging a battery using MSCCCV type, the electronic device 100 may start charging using about 5 A and complete charging in about 4000 seconds. At the time of completion of charging, the electronic device 100 may charge the battery using about 1.5 A.

In the embodiment of charging a battery using a battery profile corresponding to Aggressive I type, the electronic device 100 may start charging using about 6 A to 7 A and complete charging in about 3200 seconds. At the time of completion of charging, the electronic device (100) may charge the battery using about 1.5 A.

The embodiment of charging a battery using Aggressive I type may have about 800 seconds less charging time than the embodiment of charging a battery using MSCCCV type.

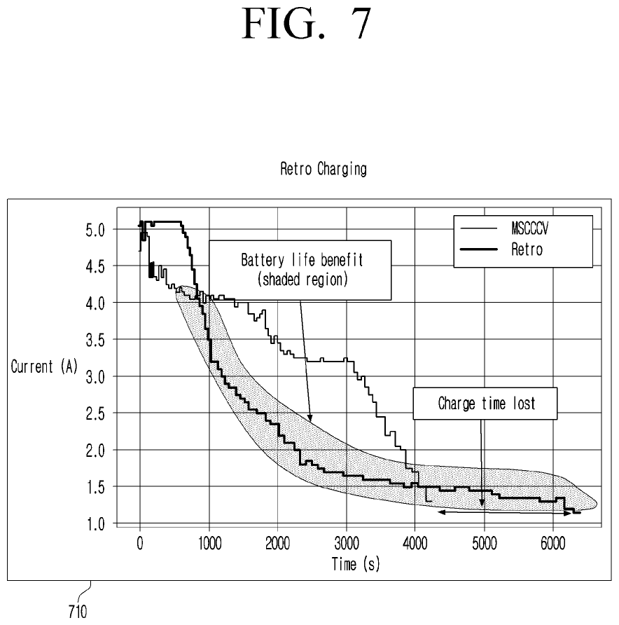

FIG. 7 is a graph provided to explain charging time and current according to one or more embodiments.

In the graph (710) of FIG. 7, an embodiment of charging a battery using MSCCCV (Multi-Step Constant Current Constant Voltage) type and an embodiment of charging a battery using a battery profile corresponding to Retro type may be compared.

In the embodiment of charging a battery using MSCCCV type, the electronic device 100 may start charging using about 5 A and complete charging in about 4000 seconds. At the time of completion of charging, the electronic device (100) may charge the battery using about 1.5 A.

In the embodiment of charging a battery using a battery profile corresponding to Retro type, the electronic device (100) may start charging using about 5 A and complete charging in about 6200 seconds. At the time of completion of charging, the electronic device (100) may charge the battery using about 1.25 A.

The embodiment of charging a battery using Retro type may have about 2200 seconds longer charging time than the embodiment of charging a battery using MSCCCV type. However, when charging a battery using Retro type, it takes more time to charge, but battery life can be extended.

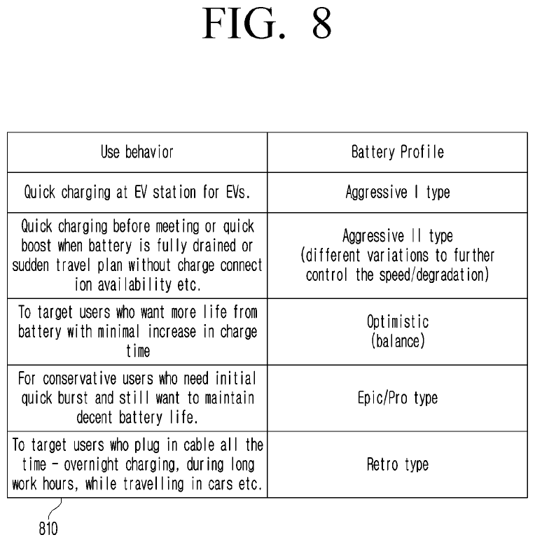

FIG. 8 is a view provided to explain an operation of determining a battery profile according to a user behavior.

Referring to a table (810) in FIG. 8, the electronic device (100) may collect user behaviors and determine a battery profile according to the collected user behaviors.

If information regarding a user having a habit of “Quick charging at EV station for EVs”, the electronic device (100) may identify the user factor as the aggressive I type.

If information regarding a user having a habit of “Quick charging before a meeting or quick boost when battery is fully drained or a sudden travel is planned without charge connect ion availability, etc.”, the electronic device (100) may identify the user factor as the aggressive II type.

If information regarding a user having a habit of “wanting more life from battery with minimal or small increase in charge time”, the electronic device (100) may identify the user factor as the optimistic type.

If information regarding a user having a habit of “needing initial quick burst and still want to maintain decent battery life”, the electronic device (100) may identify the user factor as the Epic/Pro type.

If information regarding a user having a habit of “plugging in cable all the time —overnight charging, during long work hours, while travelling in cars etc.”, the electronic device (100) may identify the user factor as the retro type.

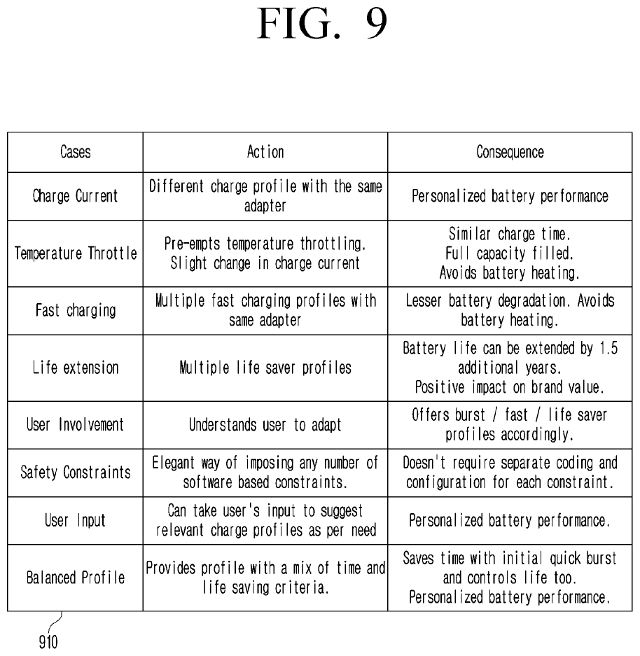

FIG. 9 is a view provided to explain a battery-related operation of the electronic device (100).

Referring to a table (910) in FIG. 9, the electronic device (100) may perform various control operations related to the battery.

The electronic device (100) may control (or perform) “different charge profile with the same adapter” based on the “charge current”. The electronic device (100) may obtain an effect for “a personalized battery performance”.

The electronic device (100) may control (or perform) “pre-empts temperature throttling” and “slight change in charge current” based on the “temperature throttle”. The electronic device (100) may obtain an effect for “similar charge time”, “full capacity filled” and “avoiding battery heating”.

The electronic device (100) may control (or perform) “multiple fast charging profiles with same adapter” based on the “fast charging”. The electronic device (100) may obtain an effect for “lesser battery degradation” and “avoiding battery heating”.

The electronic device (100) may control (or perform) “multiple life saver profiles” based on the “life extension”. The electronic device (100) may obtain an effect for “battery life extendable by 1.5 additional years” and “positive impact on brand value”.

The electronic device (100) may control (or perform) “understands user to adapt” based on the “user involvement”. The electronic device (100) may obtain an effect of “offering burst/fast/life saver profiles accordingly”.

The electronic device (100) may control (or perform) “elegant way of imposing any number of software based constraints” based on the “safety constraints”. The electronic device (100) may obtain an effect for “not requiring separate coding and configuration for each constraint”.

The electronic device (100) may control (or perform) “take user's input to suggest relevant charge profiles as per need” based on the “user input”. The electronic device (100) may obtain an effect for “personalized battery performance”.

The electronic device (100) may control (or perform) “provides profile with a mix of time and life saving criteria” based on the “balanced profile”. The electronic device (100) may obtain an effect for “saving time with initial quick burst and controlling life too” and “a personalized battery performance”.

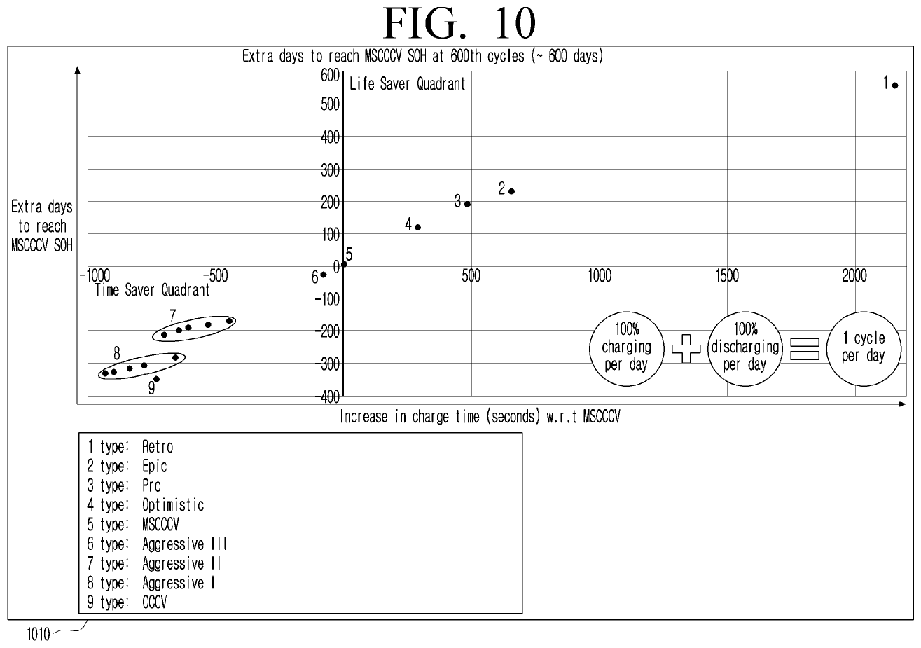

FIG. 10 is a view provided to explain a relationship between a charging time and a battery state according to various user factors.

Referring to an embodiment (1010) of FIG. 10, a reference type among various types may be a fifth type of MSCCCV (Multi-Step Constant Current Constant Voltage).

The embodiment (1010) of FIG. 10 may indicate as the charging time becomes longer (or shorter) than that of the fifth type, the battery life becomes longer (or shorter) than that of the fifth type.

“Extra days to reach MSCCCV SOH (State Of Health)” may indicate the lifespan of the battery profile.

The faster the charging speed, the shorter the lifespan of the battery.

The shorter the time taken to charge a specific amount (e.g., full charging time), the longer the lifespan of the battery.

The slower the charging speed, the longer the lifespan of the battery.

The longer the time taken to charge a specific amount (e.g., full charging time), the longer the lifespan of the battery.

In FIG. 5, Aggressive III type is not described. However, the charging speed of Aggressive III type may be slower than that of Aggressive II type and faster than that of MSCCCV.

In FIG. 5, Epic type and Pro type are not distinguished. However, the charging speed of Pro type may be faster than that of Epic type.

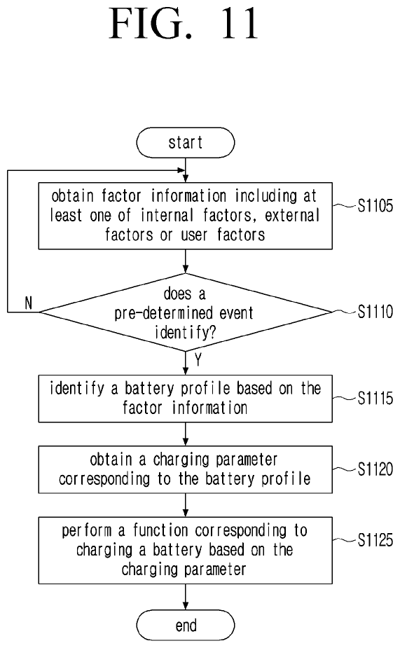

FIG. 11 is a view provided to explain a controlling method of the electronic device (100) according to one or more embodiments.

Referring to FIG. 11, the electronic device (100) may obtain factor information including at least one of internal factors, external factors or user factors (S1105).

The internal factors may include information corresponding to hardware/software components of electronic device (100).

The external factors may include information (or environment information) related to the location of the electronic device (100).

The user factors may include information related with a user behavior.

Since the detailed description regarding factor information has been described in FIG. 4, overlapping description will be omitted.

The electronic device (100) may determine whether a pre-determined event is identified or not (S1110).

The electronic device (100) may determine whether a pre-determined event is identified or not based on a user input or the factor information including at least one of internal factors, external factors or user factors.

The pre-determined event may be an event in which a user input for changing a battery usage pattern is received.

The pre-determined event may be an event in which the remaining battery is identified as being equal to or less than a threshold value.

The pre-determined event may be an event in which a pre-determined application is executed. The pre-determined application may be an application that consumes a battery faster than other applications. The pre-determined application may be set as application type or required battery.

For example, the pre-determined application may be a game application. When an application classified as a game application is executed, the electronic device (100) may determine that a pre-determined event is identified.

For example, the pre-determined application may be an application whose required memory is equal to or greater than a threshold value. A plurality of applications may store information on required memory. The required memory of a first application may be a first value, and the required memory of a second application may be a second value. The electronic device (100) may check whether the first value or the second value may be equal to or greater than a threshold value. When the first value is equal to or greater than a threshold value, the electronic device (100) may set the first application as a pre-determined application.

Based on the pre-determined event being not identified (S1110—N), the electronic device (100) may repeatedly obtain factor information.

Each embodiment herein may be used in combination with any other embodiment(s) described herein.

Based on the pre-determined event being identified (S1110—Y), the electronic device (100) may identify a battery profile based on the factor information (S1115).

The electronic device (100) identify the battery profile based on the factor information including at least one of internal factors, external factors or user factors.

The battery profile may include a charging profile.

According to at least one of embodiments, the electronic device (100) may identify the charging profile based on the factor information. The electronic device (100) may identify the charging profile based on information related with a user behavior included in the factor information.

The operation of specifying charging profile (battery profile) according to a user behavior has been described in FIG. 5 and FIG. 8, so overlapping description is omitted.

The electronic device (100) may obtain a charging parameter corresponding to the battery profile (S1120).

The electronic device (100) may obtain the charging parameter based on the battery profile.

The electronic device (100) may perform battery charging suitable for a specific battery profile.

For battery charging, detailed parameters that affect the charging method must be determined.

The charging parameters may include at least one of charging current, charging voltage, charging time, temperature of the electronic device (100), control of cooling module or control of background applications.

The electronic device (100) may perform a function corresponding to charging a battery based on the charging parameter (S1125).

The electronic device (100) may adjust (or change) charging current based on the battery profile.

For example, the electronic device (100) may perform charging by greatly changing the charging current based on a battery profile requiring fast charging.

The electronic device (100) may adjust (or change) charging voltage based on the battery profile.

For example, the electronic device (100) may perform charging by greatly changing the charging voltage based on a battery profile requiring fast charging.

The electronic device (100) may adjust (or change) charging time based on the battery profile.

For example, the electronic device (100) may change a charging method to reduce the charging time based on a battery profile requiring fast charging.

The electronic device (100) may adjust (or change) temperature of the electronic device (100) based on the battery profile.

For example, the electronic device (100) may perform charging by lowering the temperature (or set temperature) based on a battery profile requiring fast charging.

The electronic device (100) may adjust (or change) control of cooling module based on the battery profile.

The electronic device (100) may include the cooling module comprising circuitry. The cooling module may perform a function of lowering the temperature. For example, the cooling module may control a fan to lower the temperature.

For example, the electronic device (100) may perform charging by greatly changing the performance (or output) of a cooling module based on a battery profile requiring fast charging.

The electronic device (100) may adjust (or change) control of background applications based on the battery profile.

The electronic device (100) may control whether or not to run an application in consideration of the resources of a background application. For example, the electronic device (100) may forcibly terminate a background application whose resources are equal to or greater than a threshold value by considering a battery profile during charging.

The electronic device (100) may limit the number of background applications in consideration of the resources of the background resources. For example, the electronic device (100) may limit the number of running background applications to 10, and forcibly terminate any background applications exceeding 10. The 10 applications that are not terminated may be determined according to a pre-determined priority (or importance).

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. A method for on-device real-time customization of charge profiles for a battery in an electronic device, the method comprising:
determining at least one charging behavior parameter of the battery during each of a plurality of charging cycles;
determining at least one discharging behavior parameter of the battery subsequent to each said charging cycle of the plurality of charging cycles;
generating a charging profile for charging the battery based on the at least one charging behavior parameter and the at least one discharging behavior parameter; and
charging the battery using the generated charging profile for at least some subsequent charging-discharging cycles.

2. The method as claimed in claim 1, wherein the charging profile is generated by at least by applying at least one machine learning model on the at least one charging behavior parameter, and the at least one discharging behavior parameter of the battery.

3. The method as claimed in claim 1, wherein the method comprises:
determining usage characteristics of the electronic device;
modifying the generated charging profile based on the usage characteristics of the electronic device; and
charging, by the electronic device, the battery using the modified charging profile.

4. The method as claimed in claim 3, wherein the usage characteristic comprise at least one of: a user type, a current location of the electronic device, calendar events, current health characteristics of the battery, and current context of the user.

5. The method as claimed in claim 4, wherein the user type comprises at least one of: an aggressive user having full fast charging requirement, an aggressive user having partial fast charging requirement, a passive user having fast charging with better life requirement, a passive user having balanced charging requirement, and a passive user having life squeezer charging requirement.

6. The method as claimed in claim 1, wherein the at least one charging behavior parameter comprises at least one of: a charging duration for which the battery is charged, a cable plugin time, a number of times the cable is plugged in, a charging rate, a charging instance of day, and a cable plug out time.

7. The method as claimed in claim 1, wherein the at least one discharging behavior parameter comprises at least one of: an amount of battery consumed by each application of the electronic device, a duration of battery consumption of each application of the electronic device, a calendar input, a discharge rate of the battery, and a discharging instance of day for significantly different discharge rate.

8. The method as claimed in claim 4, wherein the current health characteristics of the battery comprises a state of charge of the battery, a state of health of battery, a temperature of the electronic device, surrounding of the electronic device, a resistance and/or equivalent of the battery, a fault of the battery, and a remaining usage life of the battery.

9. An electronic device for on-device real-time customization of charge profiles for a battery in the electronic device, the electronic device comprising:
a memory;
a processor; and
a charge profile customization controller comprising processing circuitry, coupled to the memory and the processor, wherein the charge profile customization controller is configured to:
determine at least one charging behavior parameter of the battery during each of a plurality of charging cycles;
determine at least one discharging behavior parameter of the battery subsequent to each said charging cycle of the plurality of charging cycles;
generate a charging profile for charging the battery based on the at least one charging behavior parameter and the at least one discharging behavior parameter; and
charge the battery using the generated charging profile for at least some subsequent charging-discharging cycles.

10. The electronic device as claimed in claim 9, wherein the controller is configured so that the charging profile is generated by at least applying at least one machine learning model on the at least one charging behavior parameter, and the at least one discharging behavior parameter of the battery.

11. The electronic device as claimed in claim 9, wherein the charge profile customization controller is configured to:
determine usage characteristics of the electronic device;
modify the generated charging profile based on the usage characteristics of the electronic device; and
charge the battery using the modified charging profile.

12. The electronic device as claimed in claim 11, wherein the usage characteristics comprise at least one of: a user type, a current location of the electronic device, calendar events, current health characteristics of the battery, and current context of the user.

13. The electronic device as claimed in claim 12, wherein the user type comprises at least one of: an aggressive user having full fast charging requirement, an aggressive user having partial fast charging requirement, a passive user having fast charging with better life requirement, a passive user having balanced charging requirement, and a passive user having life squeezer charging requirement.

14. The electronic device as claimed in claim 9, wherein the at least one charging behavior parameter comprises a charging duration for which the battery is charged, a cable plugin time, a number of times the cable is plugged in, a charging rate, a charging instance of day, and a cable plug out time.

15. The electronic device as claimed in claim 9, wherein the at least one discharging behavior parameter comprises an amount of battery consumed by each application of the electronic device, a duration of battery consumption of each application of the electronic device, a calendar input, a discharge rate of the battery, and a discharging instance of day for significantly different discharge rate.
